(19) United States
(12) Patent Application Publication
(10) Pub. No.: US 2023/0354117 A1
(43) Pub. Date: Nov. 2, 2023

(54) CELL HANDOVER METHOD AND APPARATUS

(71) Applicant: HUAWEI TECHNOLOGIES CO., LTD., Shenzhen (CN)

(72) Inventors: Shitong YUAN, Chengdu (CN); Peng GUAN, Shenzhen (CN); Bo FAN, Chengdu (CN); Xi ZHANG, Chengdu (CN); Lei CHEN, Chengdu (CN)

(21) Appl. No.: 18/338,941

(22) Filed: Jun. 21, 2023

Related U.S. Application Data
(63) Continuation of application No. PCT/CN2020/138687, filed on Dec. 23, 2020.

(51) Int. Cl. H04W 36/00

(52) U.S. Cl. CPC H04W 36/0072

(57) ABSTRACT

A cell handover method and an apparatus. Indication information is received from a source cell, where the indication information indicates to a first transmission configuration indicator TCI state and cell handover; initiating random access to a target cell according to the indication information. In response to first response information returned by the target cell being received, second response information is returned to the source cell, where the second response information indicates that the first TCI state is successfully activated. Cell handover is implemented through beam switch to reduce a delay of a terminal device during the cell handover. The terminal device returns the second response information to the source cell only after receiving the first response information returned by the target cell.

### CROSS-REFERENCE TO RELATED APPLICATIONS

This application is a continuation of International Application No. PCT/CN2020/138687, filed on Dec. 23, 2020, the disclosure of which is hereby incorporated by reference in its entirety.

### TECHNICAL FIELD

This application relates to the field of communication technologies, and in particular, to a cell handover method and an apparatus.

### BACKGROUND

A beamforming (beamforming) technology can concentrate signals in one direction for transmission, to compensate for path loss. A network device and a terminal device communicate with each other through a beam. As the terminal device moves or the like, handover between cells occurs on the terminal device. A layer 3 (layer 3, L3) control mechanism, that is, a radio resource control (radio resource control, RRC) protocol layer control mechanism, is used in response to cell handover occurs because the terminal device moves between the cells. Specifically, a source cell of the terminal device configures a reference signal measurement configuration of a neighboring cell for the terminal device. A network device of the neighboring cell sends a reference signal for each beam through beam scanning. The terminal device measures reference signals of the neighboring cell, selects a proper reference signal, and notifies the network device of the neighboring cell of the selected reference signal during initial access to the neighboring cell, so that the network device of the neighboring cell learns of a beam corresponding to the reference signal selected by the terminal device.

However, a delay of a current cell handover method is large, and how to reduce the delay of cell handover is a problem that is to be resolved.

### SUMMARY

Embodiments described herein provide a cell handover method and an apparatus, to reduce a delay of a terminal device during cell handover.

According to a first aspect, a cell handover method is provided. The method is performed by a terminal device, or is performed by a component (such as a processor, a chip, or a chip system) of the terminal device. The method is implemented by the following steps: receiving indication information from a source cell, where the indication information indicates to activate a first transmission configuration indicator (transmission configuration indicator, TCI) state; initiating random access to a target cell according to the indication information; and in response to the first response information returned by the target cell being received, returning second response information to the source cell, where the second response information indicates that the first TCI state is successfully activated. Implementing cell handover through beam switch reduces a delay of the terminal device during the cell handover. The terminal device returns the second response information to the source cell only after receiving the first response information returned by the target cell. An improved feedback mechanism improves reliability of the terminal device during the beam switch-based cell handover.

In a possible design, the first TCI state indicates a first reference signal; and the initiating random access to a target cell according to the indication information is implemented in the following manner initiating the random access to the target cell based on a first random access resource associated with the first reference signal. The target cell learns of an association relationship between a reference signal and a random access resource. In response to receiving a random access request initiated by the terminal device based on the first random access resource, the target cell determines a target beam that the terminal device wants to access.

In a possible design, a plurality of reference signals of the target cell are associated with a plurality of random access resources, and the first reference signal is one of the plurality of reference signals.

In a possible design, the first TCI state indicates the first reference signal; and the initiating random access to a target cell according to the indication information is implemented in the following manner sending a scheduling request (scheduling request, SR) or sending a MAC-CE defined in a protocol to the target cell based on a first uplink control channel resource associated with the first reference signal. The target cell learns of an association relationship between a reference signal and an uplink control channel resource. In response to receiving the scheduling request (SR) or the MAC-CE defined in the protocol initiated by the terminal device based on the first uplink control channel resource, the target cell determines a target beam that the terminal device wants to access.

Optionally, a plurality of reference signals of the target cell are associated with a plurality of uplink control channel resources, and the first reference signal is one of the plurality of reference signals.

The source cell configures the association relationship between the reference signal and the random access resource for the terminal device in advance, and the terminal device obtains the association relationship from the source cell. The association relationship is obtained by the source cell by using a received system message of the target cell. The terminal device determines the random access resource based on a configuration of the random access resource of the target cell, and initiates the random access to the target cell. Alternatively, after receiving the indication information from the source cell, the terminal device attempts to receive system information or a broadcast message in the target cell, obtain the configuration of the random access resource, and initiate the random access in the target cell.

In a possible design, the first response information includes response information used to respond to the random access. For example, the first response information is a random access response or other information used to respond to the random access. The terminal device considers that the random access succeeds only after receiving the response information that is used to respond to the random access that is returned by the target cell, and further returns the second response information to the source cell. The source cell considers that beam switch succeeds or considers that activation of the first TCI succeeds only after receiving the second response information. In this way, cell handover reliability is improved.

In a possible design, the terminal device alternatively attempts to send uplink data or an uplink signal in the target cell after receiving the indication information from the source cell, where the uplink data includes data on a PUSCH and data on a PUCCH, and the uplink signal includes an SRS sounding reference signal. Optionally, the first response information is response information used to respond to the uplink signal or the uplink data.

In a possible design, the first TCI state indicates the first reference signal, and the method further includes the following steps: after the random access is initiated to the target cell, in response to a beam failure occurring, performing beam failure recovery based on a candidate beam configuration of the first reference signal. In response to beam switch-based cell handover failing, the terminal device quickly attempts the beam failure recovery in the target cell by using the candidate beam configuration, so that reliability of the terminal device during beam switch— based cell handover is improved.

In a possible design, the first response information includes response information used to respond to the beam failure recovery. For example, the first response information is a beam failure recovery request response, or other information that is used to respond to the beam failure recovery. After the terminal device performs the beam switch-based cell handover, a beam switch failure occurs. After receiving the response information used to respond to the beam failure recovery, the terminal device returns, to the source cell, the second response message that indicates that activation of the first TCI state succeeds, cell handover succeeds, or beam switch succeeds. In this way, reliability and robustness of successful cell handover is further ensured.

In a possible design, the performing beam failure recovery based on a candidate beam configuration of the first reference signal is implemented in the following manner measuring one or more reference signals in the candidate beam configuration of the first reference signal; selecting a second reference signal in the candidate beam configuration according to a measurement result; and sending a beam failure recovery request to the target cell based on the uplink resource associated with the second reference signal.

In a possible design, the method further includes: receiving configuration information from the source cell, where the configuration information includes a downlink resource used to receive the beam failure recovery request response; and receiving the beam failure recovery request response from the target cell based on the downlink resource. The configuration information of the downlink resource is received, so that the beam failure recovery request response of the target cell is received on the downlink resource, thereby completing the beam failure recovery.

In a possible design, in response to the first response information returned by the target cell not being received, communication is performed with the source cell based on a second TCI state used before the first TCI state is successfully activated. For example, a PDCCH from the source cell is received based on a QCL relationship indicated by the second TCI state. In response to the cell handover failing, the terminal device remains in the source cell to continue communication, so the terminal device does not return to an RRC initial state because the terminal device is disconnected from the network due to a radio link failure, thereby ensuring normal communication of the terminal device.

According to a second aspect, a cell handover method is provided. The method is performed by a terminal device, or is performed by a component (such as a processor, a chip, or a chip system) of the terminal device. The method is implemented by the following steps: The terminal device receives indication information from a source cell, where the indication information indicates to activate a first TCI state, and initiates random access to a target cell according to the indication information. In response to a beam failure occurring, the terminal device performs beam failure recovery based on a candidate beam configuration of a first reference signal, where the first TCI state indicates the first reference signal, and in response to response information that is used to respond to the beam failure recovery and that is returned by the target cell being received, returns second response information to the source cell. The source cell receives the second response information from the terminal device, where the second response information indicates that the first TCI state is successfully activated. In response to beam switch-based cell handover failing, the terminal device quickly attempts the beam failure recovery in the target cell by using the candidate beam configuration, so that reliability of the terminal device during the beam switch-based cell handover is improved.

In a possible design, the first TCI state indicates the first reference signal; and the initiating random access to a target cell according to the indication information is implemented in the following manner initiating the random access to the target cell based on a first random access resource associated with the first reference signal. The target cell learns of an association relationship between a reference signal and a random access resource. In response to receiving a random access request initiated by the terminal device based on the first random access resource, the target cell determines a target beam that the terminal device wants to access.

In a possible design, a plurality of reference signals of the target cell are associated with a plurality of random access resources, and the first reference signal is one of the plurality of reference signals.

In a possible design, the first TCI state indicates the first reference signal; and the initiating random access to the target cell according to the indication information is implemented in the following manner sending a scheduling request (scheduling request, SR) or sending a MAC-CE defined in a protocol to the target cell based on a first uplink control channel resource associated with the first reference signal. The target cell learns of an association relationship between a reference signal and an uplink control channel resource. In response to receiving the scheduling request (SR) or the MAC-CE defined in the protocol initiated by the terminal device based on the first uplink control channel resource, the target cell determines a target beam that the terminal device wants to access.

Optionally, a plurality of reference signals of the target cell are associated with a plurality of uplink control channel resources, and the first reference signal is one of the plurality of reference signals.

The source cell configures the association relationship between the reference signal and the random access resource for the terminal device in advance, and the terminal device obtains the association relationship from the source cell. The association relationship is obtained by the source cell by using a received system message of the target cell. The terminal device determines the random access resource based on a configuration of the random access resource of the target cell, and initiates the random access to the target cell. Alternatively, after receiving the indication information from the source cell, the terminal device attempts to receive system information or a broadcast message in the target cell, obtain the configuration of the random access resource, and initiate the random access in the target cell.

In a possible design, the terminal device alternatively attempts to send uplink data or an uplink signal in the target cell after receiving the indication information from the source cell, where the uplink data includes data on a PUSCH and data on a PUCCH, and the uplink signal includes an SRS sounding reference signal. Optionally, the first response information is response information used to respond to the uplink signal or the uplink data.

In a possible design, the performing beam failure recovery based on a candidate beam configuration of the first reference signal is implemented in the following manner measuring one or more reference signals in the candidate beam configuration of the first reference signal; selecting a second reference signal in the candidate beam configuration according to a measurement result; and sending a beam failure recovery request to the target cell based on the uplink resource associated with the second reference signal.

In a possible design, the method further includes: receiving configuration information from the source cell, where the configuration information includes a downlink resource used to receive the beam failure recovery request response; and receiving the beam failure recovery request response from the target cell based on the downlink resource. The configuration information of the downlink resource is received, so that the beam failure recovery request response of the target cell is received on the downlink resource, thereby completing the beam failure recovery.

In a possible design, in response to the first response information returned by the target cell not being received, communicate with the source cell based on a second TCI state used before the first TCI state is successfully activated. For example, a PDCCH from the source cell is received based on a QCL relationship indicated by the second TCI state. In response to the cell handover failing, the terminal device remains in the source cell to continue communication, so that the terminal device does not return to an RRC initial state because the terminal device is disconnected from the network due to a radio link failure, thereby ensuring normal communication of the terminal device.

According to a third aspect, a cell handover method is provided. The method is performed by a source cell, or is performed by a component (such as a processor, a chip, or a chip system) of the source cell. An operation performed by the source cell is performed by a network device in which the source cell is located. The method is implemented by the following steps: sending indication information to a terminal device based on a quasi-colocation QCL relationship indicated by a first TCI state, where the indication information indicates to activate a second TCI state, and the indication information is used by the terminal device to initiate random access to a target cell; and receiving an acknowledgement from the terminal device, where the acknowledgement indicates that the second TCI state is successfully activated. The indication information indicates to activate the second TCI state of the target cell, so that cell handover is implemented through beam switch, thereby reducing a cell handover delay.

Generally, the acknowledgement is sent by using physical layer signaling, or is sent by using MAC layer signaling. A delay of the physical layer and the MAC layer is lower than that of a layer 3, that is, an RRC layer. Therefore, the delay of a cell handover is reduced.

In a possible design, in response to a negative acknowledgement being received from the terminal device, communication is performed with the terminal device by using the QCL relationship indicated by the first TCI state. The negative acknowledgement indicates that the cell handover fails. Communication with the terminal device is continued In response to the cell handover failing, the terminal device does not return to an RRC initial state because the terminal device is disconnected from a network due to a radio link failure, thereby ensuring normal communication of the terminal device.

In a possible design, configuration information is requested from the target cell, where the configuration information includes a downlink resource used by the terminal device to receive a beam failure recovery request response; and the configuration information is received from the target cell. By requesting the configuration information from the target cell, the downlink resource used to receive the beam failure recovery request response is indicated to the terminal device, so that the terminal device receives the beam failure recovery request response from the target cell on the downlink resource.

According to a fourth aspect, a communication apparatus is provided. The communication apparatus is a terminal device, or is an apparatus located in the terminal device (for example, a chip, a chip system, or a circuit), or an apparatus that is used in matching with the terminal device. In a design, the apparatus includes modules that are in a one-to-one correspondence with the method/operation/step/action described in the first aspect. The modules is implemented by a hardware circuit, software, or a combination of the hardware circuit and software. In a design, the apparatus includes a processing module and a communication module. The processing module is configured to invoke the communication module to perform a receiving and/or sending function. The communication module is also referred to as a transceiver module, and further includes a sending module and a receiving module. Specifically, the sending module is configured to implement the sending operation in the foregoing method, and the receiving module is configured to implement the receiving operation in the foregoing method. Other operations are implemented by the processing module. For example, the communication module is configured to receive indication information from a source cell, where the indication information indicates to activate a first TCI state. The processing module is configured to initiate random access to a target cell according to the indication information, and is configured to: in response to being determined that the communication module receives first response information returned by the target cell, return second response information to the source cell by using the communication module, where the second response information indicates that the first TCI state is successfully activated. The terminal device returns the second response information to the source cell only after receiving the first response information returned by the target cell. An improved feedback mechanism improves reliability of the terminal device during the beam switch-based cell handover.

In a possible design, the first TCI state indicates the first reference signal; and In response to initiating the random access to the target cell according to the indication information, the processing module is specifically configured to initiate the random access to the target cell based on a first random access resource associated with the first reference signal. The target cell learns of an association relationship between a reference signal and a random access resource. In response to receiving a random access request initiated by the terminal device based on the first random access resource, the target cell determines a target beam that the terminal device wants to access.

In a possible design, a plurality of reference signals of the target cell are associated with a plurality of random access resources, and the first reference signal is one of the plurality of reference signals.

In a possible design, the first TCI state indicates the first reference signal; and in response to initiating the random access to the target cell according to the indication information, the processing module is specifically configured to send a scheduling request (scheduling request, SR) or send a MAC-CE defined in a protocol to the target cell based on a first uplink control channel resource associated with the first reference signal. The target cell learns of an association relationship between a reference signal and an uplink control channel resource. In response to receiving the scheduling request (SR) or the MAC-CE defined in the protocol initiated by the terminal device based on the first uplink control channel resource, the target cell determines a target beam that the terminal device wants to access.

Optionally, a plurality of reference signals of the target cell are associated with a plurality of uplink control channel resources, and the first reference signal is one of the plurality of reference signals.

The source cell configures the association relationship between the reference signal and the random access resource for the terminal device in advance, and the processing module is further configured to obtain the association relationship from the source cell. The association relationship is obtained by the source cell by using a received system message of the target cell.

The processing module is configured to determine the random access resource based on a configuration of the random access resource of the target cell, and initiate the random access to the target cell. Alternatively, after receiving the indication information from the source cell by using the communication module, the processing module attempts to receive system information or a broadcast message in the target cell, obtain the configuration of the random access resource, and initiate the random access in the target cell.

In a possible design, the terminal device alternatively attempts to send uplink data or an uplink signal in the target cell after receiving the indication information from the source cell, where the uplink data includes data on a PUSCH and data on a PUCCH, and the uplink signal includes an SRS sounding reference signal. Optionally, the first response information is response information used to respond to the uplink signal or the uplink data.

In a possible design, the first response information includes response information used to respond to the random access. For example, the first response information is a random access response or other information that is used to respond to the random access. The terminal device considers that the random access succeeds only after receiving the response information that is used to respond to the random access that is returned by the target cell, and further returns the second response information to the source cell. The source cell considers that beam switch succeeds or considers that activation of the first TCI succeeds only after receiving the second response information. In this way, cell handover reliability is improved.

In a possible design, the first TCI state indicates the first reference signal, and the processing module is further configured to: after initiating the random access to the target cell, in response to a beam failure occurring, perform beam failure recovery based on a candidate beam configuration of the first reference signal. In response to beam switch-based cell handover failing, the terminal device quickly attempts the beam failure recovery in the target cell by using the candidate beam configuration, so that reliability of the terminal device during the beam switch— based cell handover is improved.

In a possible design, the first response information includes response information used to respond to the beam failure recovery. For example, the first response information is a beam failure recovery request response, or other information used to respond to the beam failure recovery. After the terminal device performs the beam switch-based cell handover, a beam switch failure occurs. After receiving the response information used to respond to the beam failure recovery, the terminal device returns, to the source cell, the second response message that indicates that activation of the first TCI state succeeds, cell handover succeeds, or beam switch succeeds. In this way, reliability and robustness of successful cell handover is further ensured.

In a possible design, in response to performing the beam failure recovery based on the candidate beam configuration of the first reference signal, the processing module is specifically configured to: measure one or more reference signals in the candidate beam configuration of the first reference signal; select a second reference signal in the candidate beam configuration according to a measurement result; and send a beam failure recovery request to the target cell based on the uplink resource associated with the second reference signal.

In a possible design, the communication module is further configured to: receive configuration information from the source cell, where the configuration information includes a downlink resource used to receive the beam failure recovery request response; and the processing module is further configured to receive the beam failure recovery request response from the target cell based on the downlink resource. The configuration information of the downlink resource is received, so that the beam failure recovery request response of the target cell is received on the downlink resource, thereby completing the beam failure recovery.

In a possible design, the processing module is further configured to: in response to the first response information returned by the target cell not being received, communicate with the source cell based on a second TCI state used before the first TCI state is successfully activated. For example, a PDCCH from the source cell is received based on a QCL relationship indicated by the second TCI state. In response to the cell handover failing, the terminal device remains in the source cell to continue communication, the terminal device does not return to an RRC initial state because the terminal device is disconnected from the network due to a radio link failure, thereby ensuring normal communication of the terminal device. Alternatively, the processing module is further configured to: in response to the first response information returned by the target cell not being received, communicate with the source cell based on the second TCI state used before the first TCI state is successfully activated. In response to the processing module determining that the first response information returned by the target cell is not received, the processing module communicates with the source cell based on the second TCI state used before the first TCI state is successfully activated.

According to a fifth aspect, a communication apparatus is provided. The communication apparatus is a terminal device, or is an apparatus located in the terminal device (for example, a chip, a chip system, or a circuit), or an apparatus that is used in matching with the terminal device. In a design, the apparatus includes modules that are in a one-to-one correspondence with the method/operation/step/action described in the second aspect. The modules is implemented by a hardware circuit, software, or a combination of the hardware circuit and software. In a design, the apparatus includes a processing module and a communication module. The processing module is configured to invoke the communication module to perform a receiving and/or sending function. The communication module is also referred to as a transceiver module, and further includes a sending module and a receiving module. Specifically, the sending module is configured to implement the sending operation in the foregoing method, and the receiving module is configured to implement the receiving operation in the foregoing method. Other operations are implemented by the processing module. For example, the communication module is configured to receive indication information from a source cell, where the indication information indicates to activate a first TCI state. The processing module is configured to: initiate random access to a target cell according to the indication information, and in response to a beam failure occurring, perform beam failure recovery based on a candidate beam configuration of a first reference signal, where the first TCI state indicates the first reference signal; and in response to response information that is used to respond to the beam failure recovery and that is returned by the target cell being received, return second response information to the source cell. The source cell receives the second response information from the terminal device, where the second response information indicates that the first TCI state is successfully activated. In response to beam switch— based cell handover failing, the terminal device quickly attempts the beam failure recovery in the target cell by using the candidate beam configuration, so that reliability of the terminal device during beam switch-based cell handover is improved.

In a possible design, the first TCI state indicates the first reference signal; and in response to initiating the random access to the target cell according to the indication information, the processing module is specifically configured to initiate the random access to the target cell based on a first random access resource associated with the first reference signal. The target cell learns of an association relationship between the reference signal and the random access resource. In response to receiving a random access request initiated by the terminal device based on the first random access resource, the target cell determines a target beam that the terminal device wants to access.

In a possible design, a plurality of reference signals of the target cell are associated with a plurality of random access resources, and the first reference signal is one of the plurality of reference signals.

In a possible design, the first TCI state indicates the first reference signal; and in response to initiating the random access to the target cell according to the indication information, the processing module is specifically configured to send a scheduling request (scheduling request, SR) or send a MAC-CE defined in a protocol to the target cell based on a first uplink control channel resource associated with the first reference signal. The target cell learns of an association relationship between a reference signal and an uplink control channel resource. In response to receiving the scheduling request (SR) or the MAC-CE defined in the protocol initiated by the terminal device based on the first uplink control channel resource, the target cell determines a target beam that the terminal device wants to access.

Optionally, a plurality of reference signals of the target cell are associated with a plurality of uplink control channel resources, and the first reference signal is one of the plurality of reference signals.

The source cell configures the association relationship between the reference signal and the random access resource for the terminal device in advance, and the processing module is further configured to obtain the association relationship from the source cell. The association relationship is obtained by the source cell by using a received system message of the target cell. The processing module is configured to determine the random access resource based on a configuration of the random access resource of the target cell, and initiate the random access to the target cell. Alternatively, after receiving the indication information from the source cell by using the communication module, the processing module attempts to receive system information or a broadcast message in the target cell, obtain the configuration of a random access resource, and initiate the random access in the target cell.

In a possible design, the terminal device alternatively attempts to send uplink data or an uplink signal in the target cell after receiving the indication information from the source cell, where the uplink data includes data on a PUSCH and data on a PUCCH, and the uplink signal includes an SRS sounding reference signal. Optionally, the first response information is response information used to respond to the uplink signal or the uplink data.

In a possible design, in response to performing the beam failure recovery based on the candidate beam configuration of the first reference signal, the processing module is specifically configured to: measure one or more reference signals in the candidate beam configuration of the first reference signal; select a second reference signal in the candidate beam configuration according to a measurement result; and send a beam failure recovery request to the target cell based on the uplink resource associated with the second reference signal.

In a possible design, the communication module is further configured to receive configuration information from the source cell, where the configuration information includes a downlink resource used to receive a beam failure recovery request response. The processing module is further configured to receive the beam failure recovery request response from the target cell by using the communication module based on the downlink resource. The configuration information of the downlink resource is received, so that the beam failure recovery request response of the target cell is received on the downlink resource, thereby completing the beam failure recovery.

In a possible design, the communication module is further configured to: in response to the first response information returned by the target cell is not received, communicate with the source cell based on a second TCI state used before the first TCI state is successfully activated. For example, a PDCCH from the source cell is received based on a QCL relationship indicated by the second TCI state. In response to the cell handover failing, the terminal device remains in the source cell to continue communication, the terminal device does not return to an RRC initial state because the terminal device is disconnected from the network due to a radio link failure, thereby ensuring normal communication of the terminal device. Alternatively, the processing module is further configured to: in response to the first response information returned by the target cell not being received, communicate with the source cell based on the second TCI state used before the first TCI state is successfully activated. In response to the processing module being configured to determine that the first response information returned by the target cell is not received, the processing module communicates with the source cell based on the second TCI state used before the first TCI state is successfully activated.

According to a sixth aspect, a communication apparatus is provided. The communication apparatus is a source cell, or is an apparatus located in the source cell (for example, a chip, a chip system, or a circuit), or an apparatus that is used in matching with the source cell. An operation performed by the source cell is performed by a network device in which the source cell is located. In a design, the apparatus includes modules that are in a one-to-one correspondence with the method/operation/step/action described in the third aspect. The modules is implemented by a hardware circuit, software, or a combination of the hardware circuit and software. In a design, the apparatus includes a processing module and a communication module. The processing module is configured to invoke the communication module to perform a receiving and/or sending function. The communication module is also referred to as a transceiver module, and further includes a sending module and a receiving module. Specifically, the sending module is configured to implement the sending operation in the foregoing method, and the receiving module is configured to implement the receiving operation in the foregoing method. Other operations are implemented by the processing module. For example, the processing module is configured to send, by using the communication module, indication information to the terminal device based on a quasi-colocation QCL relationship indicated by a first TCI state, where the indication information indicates to activate a second TCI state, and the indication information is used by the terminal device to initiate random access to a target cell. The communication module is further configured to receive an acknowledgement from the terminal device, where the acknowledgement indicates that the second TCI state is successfully activated. The indication information indicates to activate the second TCI state of the target cell, so that cell handover is implemented through beam switch, thereby reducing a cell handover delay.

Generally, the acknowledgement is sent by using physical layer signaling, or is sent by using MAC layer signaling. A delay of the physical layer and the MAC layer is lower than that of a layer 3, that is, an RRC layer. Therefore, the delay of a cell handover is reduced.

In a possible design, the processing module is configured to: in response to a negative acknowledgement being received from the terminal device, communicate with the terminal device by using the QCL relationship indicated by the first TCI state. The negative acknowledgement indicates that the cell handover fails. Communication with the terminal device is continued in response to the cell handover failing, the terminal device does not return to an RRC initial state because the terminal device is disconnected from a network due to a radio link failure, thereby ensuring normal communication of the terminal device.

In a possible design, the processing module is further configured to request configuration information from the target cell, where the configuration information includes a downlink resource used by the terminal device to receive a beam failure recovery request response; and the communication module is further configured to receive the configuration information from the target cell. By requesting the configuration information from the target cell, the downlink resource used to receive the beam failure recovery request response is indicated to the terminal device, so that the terminal device receives the beam failure recovery request response from the target cell on the downlink resource.

According to a seventh aspect, at least one embodiment provides a communication apparatus, where the communication apparatus includes a communication interface and a processor, and the communication interface is used by the apparatus to communicate with another device, for example, to send and receive data or a signal. For example, the communication interface is a transceiver, a circuit, a bus, a module, or another type of communication interface, and the another device is a network device of a source cell or a target cell. The processor is configured to invoke a group of programs, instructions, or data, to perform the method described in the first aspect or the second aspect. The apparatus further includes a memory, and the memory is configured to store programs, instructions, or data invoked by the processor. The memory is coupled to the processor, and in response to executing the instructions or data stored in the memory, the processor implements the method described in the first aspect or the second aspect.

According to an eighth aspect, at least one embodiment provides a communication apparatus, where the communication apparatus includes a communication interface and a processor, and the communication interface is used by the apparatus to communicate with another device, for example, to send and receive data or a signal. For example, the communication interface is a transceiver, a circuit, a bus, a module, or a communication interface of another type, and the another device is a terminal device. The processor is configured to invoke a group of programs, instructions, or data, to perform the method described in the third aspect. The apparatus further includes a memory, and the memory is configured to store programs, instructions, or data invoked by the processor. The memory is coupled to the processor, and in response to executing the instructions or data stored in the memory, the processor implements the method described in the third aspect.

According to a ninth aspect, at least one embodiment further provides a computer readable storage medium, where the computer readable storage medium stores computer readable instructions, and in response to the computer readable instructions running on a computer, so that the method according to the first aspect or any one of the possible designs of the first aspect is performed; or the method according to the second aspect or any one of the possible designs of the second aspect is performed.

According to a tenth aspect, at least one embodiment further provides a computer readable storage medium, including instructions. In response to the instructions being run on a computer, the computer is enabled to perform the method according to the third aspect or any one of the possible designs of the third aspect.

According to an eleventh aspect, at least one embodiment provides a chip system. The chip system includes one or more processors, and the one or more processors are configured to execute a computer program or instructions in a memory, to implement the method in the first aspect or any one of the possible designs of the first aspect. The chip system includes a chip, or includes a chip and another discrete device.

Optionally, the chip system includes a memory, or the chip system is connected to the memory.

According to a twelfth aspect, at least one embodiment provides a chip system. The chip system includes one or more processors, and the one or more processors are configured to execute a computer program or instructions, to implement the method in the second aspect or any one of the possible designs of the second aspect. The chip system includes a chip, or includes a chip and another discrete device.

Optionally, the chip system includes a memory, or the chip system is connected to the memory.

According to a thirteenth aspect, at least one embodiment provides a chip system. The chip system includes one or more processors, and the one or more processors are configured to execute a computer program or instructions, to implement the method in the third aspect or any one of the possible designs of the third aspect. The chip system includes a chip, or includes a chip and another discrete device.

Optionally, the chip system includes a memory, or the chip system is connected to the memory.

According to a fourteenth aspect, at least one embodiment provides a communication system. The communication system includes the communication apparatus according to the fourth aspect or the fifth aspect, a communication apparatus in a source cell, and a communication apparatus in a target cell.

In a possible design, the communication apparatus in the source cell includes the communication apparatus according to the sixth aspect or the communication apparatus according to the eighth aspect.

According to a fifteenth aspect, a computer program product including instructions is provided. In response to the computer program product running on a computer, the method in the foregoing aspects and any one of the possible designs of the aspects is performed.

### BRIEF DESCRIPTION OF DRAWINGS

FIG. 1 is a schematic architectural diagram of a communication system according to at least one embodiment;

FIG. 2 is a schematic diagram of beam switch from a source cell to a target cell according to at least one embodiment;

FIG. 3 is a first schematic flowchart of a cell handover method according to at least one embodiment;

FIG. 4 is a schematic structural diagram of a MAC-CE used to activate a TCI state according to at least one embodiment;

FIG. 5 is a second schematic flowchart of a cell handover method according to at least one embodiment;

FIG. 6 is a third schematic flowchart of a cell handover method according to at least one embodiment;

FIG. 7 is a schematic flowchart of a beam switch failure according to at least one embodiment;

FIG. 8 is a fourth schematic flowchart of a cell handover method according to at least one embodiment;

FIG. 9 is a first schematic structural diagram of a communication apparatus according to at least one embodiment; and

FIG. 10 is a second schematic structural diagram of a communication apparatus according to at least one embodiment.

### DESCRIPTION OF EMBODIMENTS

Embodiments described herein provide a cell handover method and an apparatus. The method and the apparatus are based on a same technical concept or similar technical concepts. Because problem-resolving principles of the method and the apparatus are similar, mutual reference is made to implementation of the apparatus and the method, and repeated parts are not described. In descriptions of embodiments described herein, words such as “first”, “second”, and “third” are merely used for distinguishing description, and cannot be understood as indicating or implying relative importance, and cannot be understood as indicating or implying a sequence.

The cell handover method provided in embodiments described herein is applied to a 4th generation (4th generation, 4G) communication system, for example, long term evolution (long term evolution, LTE), or is applied to a 5th generation (5th generation, 5G) communication system, for example, 5G new radio (new radio, NR), or applied to various future communication systems, for example, a 6th generation (6th generation, 6G) communication system.

The following describes at least one embodiment in detail with reference to the accompanying drawings.

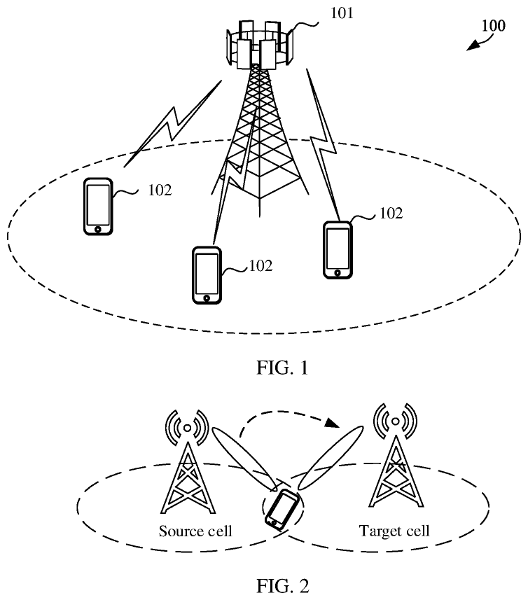

FIG. 1 shows an architecture of a possible communication system to which a cell handover method according to at least one embodiment is applicable. Refer to FIG. 1, a communication system 100 includes: a network device 101 and a terminal device 102. The network device 101 provides a service for the terminal device 102 in a coverage area.

The network device 101 is a node in a radio access network (radio access network, RAN), and is also referred to as a base station, or is referred to as a RAN node (or a device). Examples of some network devices 101 are: a next generation NodeB (next generation NodeB, gNB), a next generation evolved NodeB (next generation evolved NodeB, Ng-eNB), a transmission reception point (transmission reception point, TRP), an evolved NodeB (evolved NodeB, eNB), a radio network controller (radio network controller, RNC), a NodeB (NodeB, NB), a base station controller (base station controller, BSC), a base transceiver station (base transceiver station, BTS), an HeNB (for example, home evolved NodeB, or home NodeB, HNB), a base band unit (base band unit, BBU), and a wireless fidelity (wireless fidelity, Wi-Fi) access point (access point, AP). The network device 101 is alternatively a satellite, and the satellite is also referred to as a high-altitude platform, a high-altitude aircraft, or a satellite base station. Alternatively, the network device 101 is another device that has a network device function. For example, the network device 101 is a device that functions as a network device in device-to-device (device-to-device, D2D) communication. Alternatively, the network device 101 is a network device in a possible future communication system.

In some deployments, the network device includes a central unit (central unit, CU) and a distributed unit (distributed unit, DU). The network device further includes an active antenna unit (active antenna unit, AAU). The CU implements some functions of the network device, and the DU implements some other functions of the network device. For example, the CU is responsible for processing a non-real-time protocol and service, and implementing functions of a radio resource control (radio resource control, RRC) layer and a packet data convergence protocol (packet data convergence protocol, PDCP) layer. The DU is responsible for processing a physical layer protocol and a real-time service, and implementing functions of a radio link control (radio link control, RLC) layer, a media access control (media access control, MAC) layer, and a physical (physical, PHY) layer. The AAU implements some physical layer processing functions, RF processing functions, and functions related to an active antenna. Because information at the RRC layer is finally changed into information at the PHY layer, or is changed from the information at the PHY layer, in this architecture, higher layer signaling such as RRC layer signaling is alternatively considered to be sent by the DU, or to be sent by the DU+AAU. The network device is a device including one or more of a CU node, a DU node, and an AAU node. In addition, the CU is assigned to a network device in a radio access network (radio access network, RAN), or the CU is assigned to a network device in a core network (core network, CN). This is not limited in embodiments described herein.

The terminal device 102 is also be referred to as user equipment (user equipment, UE), a mobile station (mobile station, MS), a mobile terminal (mobile terminal, MT), or the like, and is a device that provides a user with voice and/or data connectivity. For example, the terminal device 102 includes a handheld device with a wireless connection function, a vehicle-mounted device, and the like. Currently, the terminal device 102 is: a mobile phone (mobile phone), a tablet computer, a notebook computer, a handheld computer, a mobile internet device (mobile internet device, MID), a wearable device (for example, a smart watch, a smart band, a pedometer), a vehicle-mounted device (for example, a car, a bicycle, an electric car, an airplane, a ship, a train, or a high-speed train), a virtual reality (virtual reality, VR) device, an augmented reality (augmented reality, AR) device, a wireless terminal in industrial control (industrial control), a smart home device (for example, a refrigerator, a television set, an air conditioner, or an electricity meter), an intelligent robot, a workshop device, a wireless terminal in self-driving (self-driving), a wireless terminal in remote medical surgery (remote medical surgery), a wireless terminal in a smart grid (smart grid), a wireless terminal in transportation safety (transportation safety), a wireless terminal in a smart city (smart city), or a wireless terminal in a smart home (smart home), a flying device (for example, an intelligent robot, a hot air balloon, an uncrewed aerial vehicle, or an aircraft), or the like. Alternatively, the terminal device 102 is another device that has a terminal device function. For example, the terminal device 102 is a device that functions as a terminal device in D2D communication.

Based on the system architecture shown in FIG. 1, a solution provided in embodiments described herein relates to handover between cells of a terminal device, in other words, the terminal device is handed over from one cell to another cell. A cell from which the handover is performed is referred to as a source serving cell or a source cell. A cell to which the handover is to be performed or is performed is referred to as a target serving cell or a target cell. In embodiments described herein, the source cell and the target cell are used as an example for description. As shown in FIG. 2, a terminal device performs beam communication in a source cell. Due to mobility of the terminal device or another reason, the terminal device is handed over to a target cell. After the handover, the terminal device performs the beam communication with the target cell. In embodiments described herein, the source cell and the target cell is served by a same network device, or is served by different network devices. That the terminal device performs beam communication with the source cell is understood as that the terminal device performs wireless communication with a network device of the source cell through a beam. Similarly, that the terminal device performs beam communication with the target cell is understood as that the terminal device performs wireless communication with a network device of the target cell through a beam.

A concept of a beam in embodiments described herein is first explained, to facilitate understanding by persons skilled in the art.

In an NR protocol, the beam is represented by a spatial domain filter (spatial domain filter), a spatial filter (spatial filter), a spatial domain parameter (spatial domain parameter), a spatial parameter (spatial parameter), a spatial domain setting (spatial domain setting), a spatial setting (spatial setting), quasi-colocation (quasi-colocation, QCL) information, a QCL assumption, a QCL indication, or the like. The beam is indicated by using a TCI state (state). The beam is alternatively indicated by using a spatial relation (spatial relation) parameter. Therefore, in embodiments described herein, the beam is replaced with the spatial domain filter, spatial filter, spatial domain parameter, spatial parameter, spatial domain setting, spatial setting, QCL information, QCL assumption, QCL indication, TCI state (including DL TCI state and/or UL TCI state), spatial relation (spatial relation), or the like. The above terms are also equivalent to each other. Alternatively, the beam is replaced with another term for representing a beam. This is not limited in embodiments described herein.

The beam is a wide beam, a narrow beam, or another type of beam. A beam forming technology is a beamforming technology or another technology. The beamforming technology is specifically a digital beamforming technology, an analog beamforming technology, a hybrid digital/analog beamforming technology, or the like. Optionally, a plurality of beams having a same communication characteristic or similar communication characteristics are considered as one beam. One beam is corresponding to one or more antenna ports, and is used to transmit a data channel, a control channel, a sounding signal, and the like. The one or more antenna ports forming (corresponding to) one beam is also considered as one antenna port set or one antenna port group.

In embodiments described herein, cell handover is implemented through beam switch. The beam switch is implemented through a layer 1 (layer 1, L1), that is, a physical layer (physical layer, PHY), or a layer 2 (layer 2, L2), that is, a media access control (medium access control, MAC) layer. In comparison with a control mechanism implemented through an L3, that is, an RRC protocol layer, a cell handover delay is reduced.

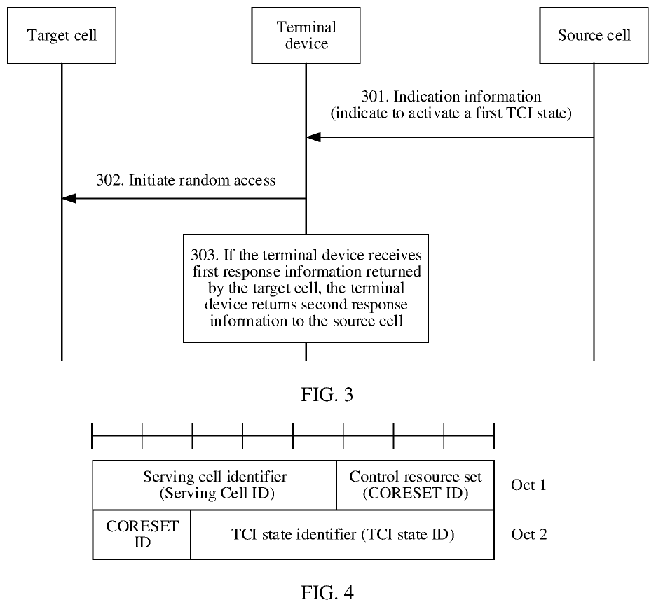

As shown in FIG. 3, the following describes in detail a specific procedure of a cell handover method according to at least one embodiment.

S301. A source cell sends indication information to a terminal device. Correspondingly, the terminal device receives the indication information from the source cell.

The indication information indicates beam switch, or the indication information indicates to activate a first TCI state, or the indication information indicates any one of a spatial relation, a beam ID, a unified TCI, a UL-TCI, a common beam, QCL information, a QCL assumption, or a spatial filter. In response to the indication information indicating to activate the first TCI state, the indication information includes an identifier (TCI state ID) of the first TCI state.

S302. The terminal device initiates random access to a target cell according to the indication information.

S303. In response to the terminal device receiving first response information returned by the target cell, the terminal device returns second response information to the source cell.

In at least one embodiment, response information is also referred to as a response message. For example, the first response information is referred to as a first response message, and the second response information is referred to as a second response message.

The second response information is used to respond to the indication information received in S301. For example, in S301, the indication information indicates the beam switch, and the second response information indicates that the beam switch succeeds. For another example, in S301, the indication information indicates to activate the first TCI state, and the second response information indicates that the first TCI state is successfully activated. The second response information is acknowledgement (acknowledge, ACK) information. Alternatively, the second response information indicates that: The terminal device successfully receives physical downlink control channel (physical downlink control channel, PDCCH) information based on a QCL relationship indicated by the first TCI. Alternatively, the second response information indicates that: The terminal device receives the PDCCH information based on the QCL relationship indicated by the first TCI, and successfully receives physical downlink shared channel (physical downlink shared channel, PDSCH) information based on scheduling of the PDCCH information.

The indication information is L1 or L2 layer signaling. Generally, after receiving the indication information at the L1 or L2, the terminal device returns a response to the indication information at fixed time. In response to a conventional feedback mechanism being used, after receiving the response returned by the terminal device, the source cell considers that the beam switch of the terminal device succeeds. However, the beam switch of the terminal device fails, in other words, the cell handover fails. In response to beam switch-based cell handover of the terminal device failing, the terminal device has a radio link interruption, disconnects from a network and returns to an RRC initial state. Reliability of successful cell handover cannot be ensured. In at least one embodiment, the terminal device returns the second response information to the source cell only after receiving the first response information returned by the target cell. An improved feedback mechanism improves reliability of the terminal device during the beam switch— based cell handover.

The following further describes in detail an optional implementation of the cell handover method provided in at least one embodiment.

Before the source cell sends the indication information to the terminal device in S301, the source cell sends a physical layer measurement configuration to the terminal device, and the terminal device receives the physical layer measurement configuration from the source cell. The physical layer measurement configuration includes reference signal information of a neighboring cell, for example, a downlink reference signal of the neighboring cell. The downlink reference signal is a synchronization signal/physical broadcast channel block (synchronization signal/physical broadcast channel block, SS/PBCH block), and the SS/PBCH block is referred to as a synchronization signal block (synchronization signal block, SSB) for short, a sounding reference signal (sounding reference signal, SRS), a demodulation reference signal (demodulation reference signal, DMRS), a channel state information reference signal (channel state information reference signal, CSI-RS), a cell specific reference signal (cell specific reference signal, CSI-RS), a tracking reference signal (tracking reference signal, TRS), or the like. The terminal device measures the downlink reference signal of the neighboring cell based on the physical layer measurement configuration. The terminal device reports a measurement result of the neighboring cell downlink reference signal to the source cell, and the source cell sends the indication information to the terminal device according to the measurement result. The indication information includes one or more of an identifier of the terminal device, an identifier of the neighboring cell, a bandwidth part (BWP) identifier, a carrier (component carrier, CC) identifier, an identifier of a random access resource, or an identifier of a target beam. The identifier of the target beam is replaced with an identifier that represents another parameter of the beam.

In S301, the source cell sends indication information to the terminal device. The indication information is a beam switch indication, and indicates beam switch. The terminal device performs the cell handover according to the indication information of the source cell, to implement the beam switch-based cell handover. In at least one embodiment, the beam indication is implemented in the following manner.

In downlink transmission, a network device indicates a transmission configuration number (index) state TCI state to the terminal device. The TCI state is a parameter set and includes a plurality of parameters related to a downlink transmit beam (a transmit beam of the network device). Therefore, in at least one embodiment, the beam and the TCI state is considered to be equivalent, and is replaced with each other. For example, in S301, indicating the beam switch by the indication information is also considered as indicating to activate the TCI state (TCI state). The network device is a network device of the source cell. The following uses the source cell as an example for description.

First, the source cell configures the TCI state for the terminal device, and the terminal device receives the TCI state from the source cell.

The source cell configures a plurality of TCI states for the terminal device by using RRC signaling. Each TCI state includes an index TCI stateId field and two QCL-Info fields. Each QCL-Info field includes a cell (cell) field, further includes a bwp-Id (bandwidth part (bandwidth part, BWP)) field, a referenceSignal (reference signal) field, and a qcl-Type field. The cell field indicates that the TCI state is applied to a cell indicated by the cell field. Different QCL-Info is configured for different cells, and different QCL-Info is configured for different BWPs of a cell. The bwp-Id field indicates a BWP that is indicated by the bwp-Id field and in which a reference signal in the TCI state is located. The referenceSignal field indicates that a channel or signal transmitted in the TCI state and a reference signal indicated by the referenceSignal field form a quasi-co-location (quasi-co-location, QCL) relationship. The channel transmitted in the TCI state is, for example, a PDSCH or a PDCCH. The QCL relationship refers to: In response to receiving the two reference signals, a terminal assumes some same receiving compensation and/or spatial filtering parameters. Alternatively, two reference signal resources is replaced with two antenna ports, and the antenna ports are in a one-to-one correspondence with the reference signal resources. Which receiving parameters between the two reference signal resources are the same depends on a qcl-Type field in the QCL-Info. “A resource of the channel transmitted in the TCI state and a reference signal resource indicated by the referenceSignal field form a QCL relationship.”

The qcl-Type field has four values: typeA, typeB, typeC, and typeD. typeA indicates that the two reference signal resources have a same Doppler shift (that is, a frequency shift), a Doppler spread (that is, a frequency shift range), an average delay (that is, an average time shift), and a delay spread (that is, a time shift range). typeB indicates that the two reference signal resources have the same Doppler shift and Doppler spread. typeC indicates that the two reference signal resources have the same Doppler shift and average delay. typeD indicates that the terminal assumes that a same spatial receiving parameter is used to receive the two reference signal resources, which is also understood as that the network device sends the two reference signals through two same transmit beams. In the two pieces of QCL-Info included in the TCI state configured by the source cell for the terminal device, a maximum of one is of a typeD type. Alternatively, the TCI state configured by the network device does not include the QCL-info of the typeD type, and the TCI state that does not include the QCL-info of the typeD type is not used to indicate related information of the beam. Therefore, descriptions are not further provided herein.

In at least one embodiment, the TCI state configured by the source cell for the terminal device includes a TCI state of the neighboring cell.

After the source cell configures the TCI state for the terminal device, in response to determining that the terminal device is to perform the cell handover, the source cell sends signaling for activating the TCI state to the terminal device.

The PDCCH is used as an example. The TCI state for receiving the PDCCH is indicated to be activated by using a medium access control-control element (medium access control-control element, MAC-CE). In an evolved version of a protocol, the TCI state also supports indication or activation using downlink control indication DCI signaling at the physical layer. The source cell sends the MAC-CE to the terminal device, where each MAC-CE indicates only one TCI state identifier (TCI state ID) of one control resource set (control resource set, CORESET). The CORESET is a resource for the terminal device to receive the PDCCH. The terminal device determines the target beam based on a value of the TCI state ID. A MAC-CE structure used to activate the TCI-state is shown in FIG. 4.

In S301, the indication information is carried by using the MAC-CE, or is carried by using downlink control information (downlink control information, DCI).

Alternatively, the source cell indicates a TCI state by using a TCI field in the DCI. For example, the TCI field occupies three bits (bits), and represents eight different field values (codepoint). Each field value of the TCI field corresponds to an index of a TCI state, and the TCI state index uniquely identifies a TCI state. A manner of indicating the TCI state by using the DCI is also applicable to the PDSCH.

The target beam indicated by the indication information in S301 is a transmit beam used by the terminal device to send a signal, or is a receive beam used by the terminal device to receive a signal.

S302. The terminal device initiates random access to the target cell according to the indication information in S301. The terminal device initiates the random access to the target cell based on a parameter indicated by the first TCI state. A random access resource used by the terminal device to initiate the random access to the target cell is determined in the following manner: The terminal device receives the indication information in S301 to indicate to activate the first TCI state, where the first TCI state indicates one or more parameters, and the first TCI state indicates the first reference signal. There is an association relationship between the reference signal and the random access resource, the first reference signal is associated with a first random access resource, and the terminal device initiates the random access to the target cell based on the first random access resource associated with the first reference signal. The first random access resource includes a physical random access channel (physical random access channel, PRACH) time-frequency resource, and further includes a random access preamble (preamble). The PRACH time-frequency resource is represented by a PRACH transmission occasion (RACH occasion, RO). One RO represents a time-frequency resource used to transmit a preamble, includes one or more subcarriers in frequency domain, and includes one or more time domain symbols in time domain. The terminal device sends the preamble to the target cell on the PRACH time-frequency resource associated with the first reference signal. One first reference signal is corresponding to one or more PRACH time-frequency resources, and the first reference signal is associated with some or all preambles on the corresponding PRACH time-frequency resources. The target cell learns of the association relationship between the reference signal and the random access resource. In response to receiving a random access request initiated by the terminal device based on the first random access resource, the target cell determines a target beam that the terminal device wants to access. Therefore, the target cell returns the first response information to the terminal device by using the target beam.

A network side configures the association relationship between the reference signal and the random access resource for the terminal device in advance. The association relationship is that one reference signal is associated with one or more random access resources, or is that a plurality of reference signals are associated with a plurality of random access resources. Alternatively, one or more reference signals is associated with one random access resource. The reference signal for configuring the association relationship is the reference signal of the neighboring cell. The random access resource for configuring the association relationship is also a random access resource of the neighboring cell. The network side is the network device of the source cell, and the source cell obtains the association relationship from the target cell. Herein, the random access resource in the association relationship preconfigured by the network side is a dedicated random access resource, that is, a contention-free (contention-free) random access resource. The network side is a source cell, and the source cell obtains the association relationship from the target cell, and configure the association relationship for the terminal device.

Alternatively, the source cell receives a broadcast message or system information (system information), for example, SIB1 information from the target cell, where the SIB1 information includes a configuration of a random access resource, and the source cell sends the configuration of the random access resource of the target cell to the terminal device. The terminal device determines the random access resource based on the configuration of the random access resource of the target cell, and initiates the random access to the target cell. In response to the first reference signal being an SSB, the terminal device determines a corresponding random access resource based on an SSB index (index) according to a method defined in a protocol. In response to the first reference signal being a CSI-RS, the terminal device further receives an association relationship that is between the CSI-RS and the SSB and that is sent by the network, determine, by using the association relationship between the CSI-RS and the SSB, an index of the SSB associated with the CSI-RS, and then determine the random access resource.

Alternatively, after receiving the indication information from the source cell, the terminal device attempts to receive system information or a broadcast message in the target cell, obtain the configuration of the random access resource, and initiate the random access in the target cell. For example, the terminal device is not configured with the association relationship between the plurality of reference signals and the plurality of random access resources, and does not receive the system information of the target cell from the source cell. This manner is used.

In S303, the terminal device considers that the random access succeeds only after receiving the first response information returned by the target cell. Before receiving the first response information returned by the target cell, the terminal device retains a hybrid automatic repeat request (hybrid automatic repeat request, HARQ) process until the terminal device returns the second response information to the source cell.

In response to the terminal device not receiving the first response information returned by the target cell, or the terminal device does not receive, in an expected receiving time window, the first response information returned by the target cell, the terminal device returns negative acknowledgement (negative acknowledge, NACK) information to the source cell. The NACK information indicates a beam switch failure, or indicates an activation failure of the first TCI state. The terminal device performs wireless communication with the source cell based on a beam before the beam switch. For example, the terminal device receives the PDCCH based on the QCL relationship indicated by the TCI state used to communicate with the source cell. For another example, the terminal device communicates with the source cell based on the TCI state used by the source cell to send the indication information. Before receiving the second response information returned by the terminal device, the source cell retains a connection configuration to the terminal device, for example, retains a context, a carrier, a BWP, and/or a parameter configuration of each channel of the terminal device, so that after the terminal device fails to perform the beam switch or the cell handover, a communication connection with the source cell is quickly restored.

After receiving the second response information, the source cell deactivates the TCI state used by the terminal device to communicate with the source cell.

In a cell handover method based on beam switch, the terminal device implements cell handover in a beam switch process. In response to a beam failure occurring on the terminal device during the cell handover, the cell handover also fails. Based on this, at least one embodiment further provides a cell handover method, to perform link recovery in response to a beam failure occurring during the cell handover.

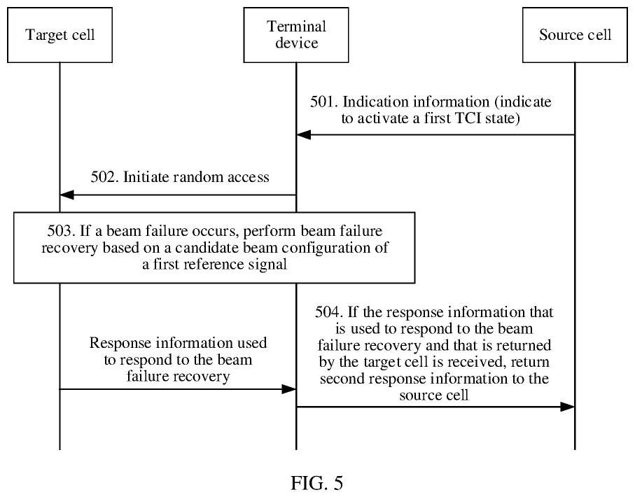

As shown in FIG. 5, a specific procedure of another cell handover method further provided in at least one embodiment is described as follows. The embodiment in FIG. 5 and the embodiment in FIG. 3 are based on a same technical concept, and reference is made to each other.

S501. A source cell sends indication information to a terminal device, and the terminal device receives the indication information from the source cell.

The indication information indicates to activate a first TCI state. This step is the same as S301, and reference is made to the descriptions of S301.

S502. The terminal device initiates random access to a target cell according to the indication information.

This step is the same as S302, and reference is made to the descriptions of S302.

S503. In response to a beam failure occurring, the terminal device performs beam failure recovery based on a candidate beam configuration of a first reference signal.

The first TCI state indicates the first reference signal.

S504. In response to the terminal device receiving response information that is used to respond to the beam failure recovery and that is returned by the target cell, the terminal device returns second response information to the source cell, and the source cell receives the second response information from the terminal device.

The second response information indicates that the first TCI state is successfully activated. For the second response information, refer to the descriptions of the second response information in the embodiment in FIG. 3.

According to the embodiment in FIG. 5, in response to beam switch-based cell handover failing, the terminal device quickly attempts the beam failure recovery in the target cell by using the candidate beam configuration, so that reliability of the terminal device during the beam switch-based cell handover is improved.

After the beam failure, the terminal device sends a beam failure recovery request to the target cell. After determining the beam failure recovery, the target cell returns response information of the beam failure recovery request to the terminal device. The response information of the beam failure recovery request is also referred to as a beam failure recovery request response. After the terminal device receives the beam failure recovery request response or after the terminal device successfully receives a PDCCH sent by the target cell for the first time, the terminal device considers that a target beam of a neighboring cell is successfully switched, or considers that a TCI state (namely, the first TCI state) of the neighboring cell is successfully activated. Before receiving the beam failure recovery request response returned by the target cell, the terminal device retains a hybrid automatic repeat request (hybrid automatic repeat request, HARQ) process until the terminal device returns the second response information to the source cell.

In response to the terminal device not receiving beam failure recovery response information returned by the target cell, the terminal device returns NACK information to the source cell, where the NACK information indicates a beam switch failure, or indicates an activation failure of the first TCI state. The terminal device performs wireless communication with the source cell based on a beam before the beam switch. For example, the terminal device receives the PDCCH based on a QCL relationship indicated by the TCI state used to communicate with the source cell. Before receiving the second response information returned by the terminal device, the source cell retains a connection configuration to the terminal device, for example, retains a context of the terminal device, so that after the terminal device fails to perform the beam switch or the cell handover, a communication connection with the source cell is quickly restored. After receiving the second response information, the source cell deactivates the TCI state used by the terminal device to communicate with the source cell.

Optionally, after receiving a random access response returned by the target cell, the terminal device returns the second response information to the source cell, to indicate that the first TCI state is successfully activated, or indicate that the beam switch is successful. This implementation is the same as S303 in the embodiment in FIG. 3.

The following describes a possible implementation of the beam failure in S503.

After initiating the random access to the target cell according to the indication information, the terminal device accesses the target cell, and performs the wireless communication with the target cell by using the target beam. For example, the indication information indicates to activate the first TCI state, and the terminal device receives a first PDCCH based on the QCL relationship indicated by the first TCI state. The terminal device performs beam quality detection on the target beam, and in response to a beam failure determining condition being met, the beam failure occurs.

The candidate beam configuration is preconfigured by the source cell for the terminal device. Optionally, the source cell sends the candidate beam configuration to the terminal device, and the terminal device receives the candidate beam configuration from the source cell. The candidate beam configuration includes a candidate beam of the target beam, or the candidate beam configuration includes one or more reference signals related to the first reference signal. The first reference signal is corresponding to the target beam, and the one or more reference signals are in a one-to-one correspondence with the candidate beam.

The source cell sends a request message to the target cell, where the request message is used to request the candidate beam configuration. The target cell receives the request message from the source cell, and returns the candidate beam configuration to the source cell. In response to the source cell and the target cell being served by a same network device, the candidate beam configuration is known without sending the request message. In response to the source cell and the target cell not being served by a same network device, a network device of the source cell sends the request message to a network device of the target cell through an Xn interface or an F1-AP interface protocol. The request message sent by the source cell to the target cell is used to request the candidate beam of the target beam, or is used to request a candidate beam of another beam. For example, the source cell requests candidate beams of a beam 1, beam 2, and beam 3 to the target cell according to a measurement result of the terminal device. The beam 1 corresponds to a reference signal 1, the beam 2 corresponds to a reference signal 2, and the beam 3 corresponds to a reference signal 3. In other words, the source cell requests a related reference signal of the reference signal 1, a related reference signal of the reference signal 2, and a related reference signal of the reference signal 3 from the target cell.

Optionally, the request message that is sent by the source cell to the target cell further includes one or more of the following information: an identifier of the terminal device, configuration information of each physical channel of the terminal device, or a result of measuring a reference signal of the neighboring cell by the terminal device.

The target cell returns a response message of the request message to the source cell, and the source cell receives the response message from the target cell. The response message of the request message includes the foregoing candidate beam configuration. Optionally, the response message of the request message further includes one or more of the following information: an uplink resource associated with the candidate beam, an uplink resource separately associated with one or more reference signals, or a downlink resource used by the terminal device to receive the beam failure recovery request response. The uplink resource is a dedicated uplink resource, and one candidate beam or one reference signal is associated with one dedicated uplink resource. Alternatively, the uplink resource is a contention-free PRACH resource, or is a scheduling request (scheduling request, SR) resource, or is another PUCCH resource or another PUSCH resource. The downlink resource for receiving the beam failure recovery request response is a PDCCH configuration for receiving the beam failure recovery request response.

The source cell sends the candidate beam configuration to the terminal device, and further sends, to the terminal device, one or more of the foregoing information included in the response message obtained from the target cell.

During the beam failure recovery in S503, the terminal device performs the following operations. The terminal device measures one or more reference signals in the candidate beam configuration of the first reference signal; selects a second reference signal in the candidate beam configuration according to the measurement result; and sends the beam failure recovery request to the target cell based on an uplink resource associated with the second reference signal. The target cell returns the beam failure recovery request response to the terminal device, and the terminal device receives the beam failure recovery request response from the target cell based on the downlink resource that is indicated by the source cell and that is used to receive the beam failure recovery request response.

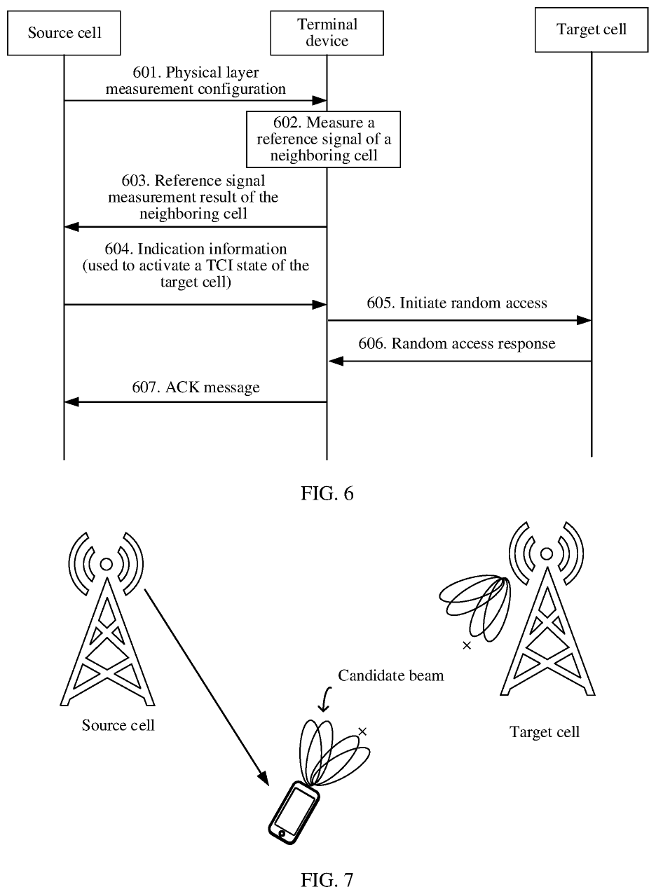

Based on the descriptions of the foregoing embodiment, as shown in FIG. 6, the following further describes a cell handover method provided in at least one embodiment in detail with reference to a specific application scenario.

S601. A source cell sends a physical layer measurement configuration to a terminal device, and the terminal device receives the physical layer measurement configuration from the source cell. S602. The terminal device measures a reference signal of a neighboring cell based on the physical layer measurement configuration.

S603. The terminal device sends a reference signal measurement result of the neighboring cell to the source cell, and the source cell receives the reference signal measurement result of the neighboring cell from the terminal device.

S604. The source cell sends indication information to the terminal device. Correspondingly, the terminal device receives the indication information from the source cell.

The indication information is beam switch indication information, or indicates to activate a TCI state of a target cell.

The source cell determines, based on the received reference signal measurement result of the neighboring cell, that the terminal device performs cell handover. The source cell selects a target cell for handover for the terminal device, and indicate, by using the indication information, the terminal device to activate the TCI state or indicate the target cell for handover.

The indication information is carried by using a MAC-CE, or is carried by using physical layer signaling.

S605. After receiving the indication information, the terminal device initiates random access to the target cell.

The terminal device initiates the random access to the target cell based on a parameter indicated by the TCI state, which is indicated to be activated by the indication information. For example, the terminal device initiates the random access to the target cell based on a QCL relationship indicated by the TCI state.

S606. The target cell returns a random access response to the terminal device. Correspondingly, the terminal device receives the random access response from the target cell.

Optionally, the target cell alternatively returns one piece of DCI to the terminal device. Correspondingly, the terminal device receives the DCI from the target cell. The DCI is used to respond to the random access in S605.

S607. After receiving the random access response, the terminal device returns an ACK message to the source cell. Correspondingly, the source cell receives the ACK message from the terminal device.

The ACK message is used to respond to the indication information in S604, to indicate that the TCI activation succeeds or beam switch succeeds.

The ACK message is carried in the MAC-CE.

Before receiving the random access response of the target cell, the terminal device keeps communicating with the source cell. In response to the beam switch failing, in other words, the cell handover fails, for example, the random access response from the target cell is not received, the terminal device performs wireless communication with the source cell, to ensure that a radio link is not interrupted.

Before receiving the ACK message, the source cell keeps a TCI used to communicate with the terminal from being deactivated. After receiving the ACK message, the source cell deactivates the TCI used to communicate with the terminal. In this way, in response to the terminal failing to be handed over, a connection to the terminal device is restored in time, so that normal communication of the terminal device is ensured.

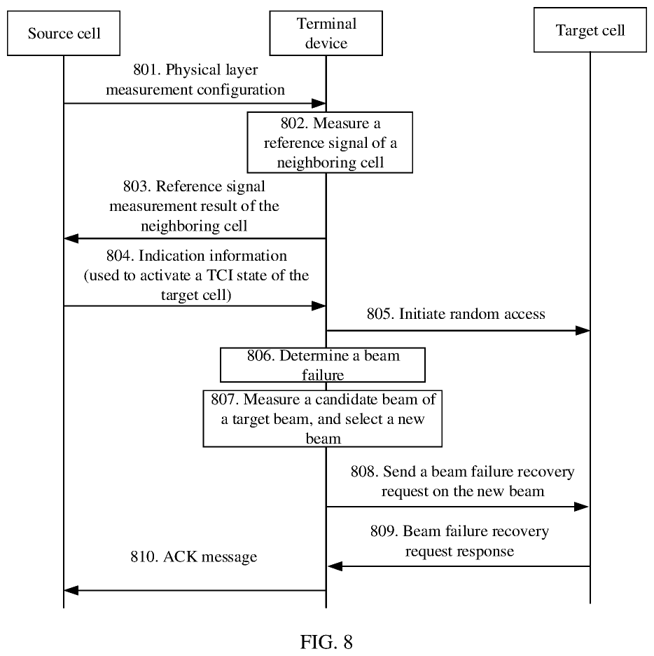

In a possible embodiment, after a terminal is handed over to a target cell, a beam failure occurs. As shown in FIG. 7, a terminal device receives L1/L2 indication information from a source cell, where the indication information indicates to activate a TCI state of the target cell. The terminal device initiates random access to the target cell, and establishes a connection to the target cell by using a target beam, but the beam failure occurs. In this case, a cell handover method provided in at least one embodiment is also shown in FIG. 8.

S801. The source cell sends a physical layer measurement configuration to the terminal device, and the terminal device receives the physical layer measurement configuration from the source cell.

S802. The terminal device measures a reference signal of a neighboring cell based on the physical layer measurement configuration.

S803. The terminal device sends a reference signal measurement result of the neighboring cell to the source cell, and the source cell receives the reference signal measurement result of the neighboring cell from the terminal device.

S804. The source cell sends indication information to the terminal device. Correspondingly, the terminal device receives the indication information from the source cell.

The indication information is beam switch indication information, or indicates to activate the TCI state of the target cell.

The source cell determines, based on the received reference signal measurement result of the neighboring cell, that the terminal device performs cell handover. The source cell selects a target cell for handover for the terminal device, and indicate, by using the indication information, the terminal device to activate the TCI state or indicate the target cell for handover.

The indication information is carried by using a MAC-CE, or is carried by using physical layer signaling.

S805. After receiving the indication information, the terminal device initiates random access to the target cell.

The terminal device initiates the random access to the target cell based on a parameter indicated by the TCI state, which is indicated to be activated by the indication information. For example, the terminal device initiates the random access to the target cell based on a QCL relationship indicated by the TCI state.

S806. The terminal device determines a beam failure.

The terminal device measures a target beam to be switched. In response to a condition being met, the terminal device determines that the beam failure occurs.

S807. The terminal device measures a candidate beam of the target beam based on preconfigured information, and selects a new beam according to a measurement result.

S808. The terminal device sends a beam failure recovery request to the target cell on an uplink resource associated with the new beam.

S809. The terminal device receives, on a downlink resource, a beam failure recovery request response from the target cell based on the preconfigured information.

One or more types of information about the candidate beam of the target beam, the uplink resource, or the downlink resource is obtained from the preconfigured information. The preconfigured information is sent by a network side to the terminal device in advance, and the network side is, for example, the source cell. The source cell can obtain the information from the target cell.

S810. The terminal device returns an ACK message to the source cell. Correspondingly, the source cell receives the ACK message from the terminal device.

The ACK message is used to respond to the indication information in S804, to indicate that the TCI activation succeeds or beam switch succeeds.

The ACK message is carried in the MAC-CE.

In application scenarios in at least one embodiment merely show some possible implementations, and are intended to better understand and describe the methods in at least one embodiment. Persons skilled in the art obtains examples of some evolved forms according to the reference signal indication method provided in at least one embodiment.

In at least one embodiment, the methods are separately described from perspectives of the network device, the terminal device, and interaction between the network device and the terminal device. To implement functions in the method provided in the foregoing embodiments described herein, the network device or the terminal device includes a hardware structure and/or a software module, and implement the foregoing functions in a form of the hardware structure, the software module, or a combination of the hardware structure and the software module. Whether a specific function in the foregoing functions is performed by the hardware structure, the software module, or the combination of the hardware structure and the software module depends on a specific application and a design constraint of the technical solutions.

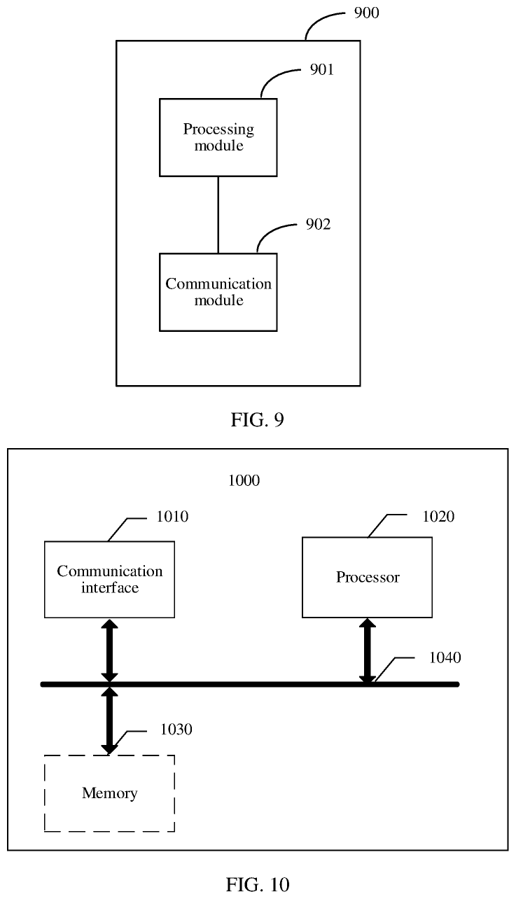

As shown in FIG. 9, based on a same technical concept, at least one embodiment further provides a communication apparatus 900. The communication apparatus 900 is a terminal device or a network device of a source cell, or is an apparatus in the terminal device or in the network device of the source cell, or an apparatus that is used in matching with the terminal device or the network device of the source cell. In a design, the communication apparatus 900 includes modules in one-to-one correspondence with execution of methods/operations/steps/actions performed by the terminal device or the network device in the foregoing method embodiments. The module is a hardware circuit, or is software, or is implemented by a combination of the hardware circuit and the software. In a design, the apparatus includes a processing module 901 and a communication module 902. The processing module 901 is configured to invoke the communication module 902 to perform a receiving and/or sending function. Further, the communication module 902 is also referred to as a transceiver module, and includes a receiving module and a sending module. The receiving module is configured to perform a receiving operation in the method embodiments, and the sending module is configured to perform a sending operation in the method embodiments. In at least one embodiment, that the processing module performs a sending or receiving operation by using the communication module is understood as follows: The processing module delivers instructions to the communication module, and the communication module performs the sending or receiving operation, or the processing module indicates the communication module to perform the sending or receiving operation.

In response to the apparatus is configured to perform the method performed by the terminal device, in an embodiment, the communication module 902 is configured to receive indication information from a source cell, where the indication information indicates to activate a first TCI state; and the processing module 901 is configured to initiate random access to a target cell according to the indication information, and is configured to: in response to being determined that the communication module receives first response information returned by the target cell, return second response information to the source cell by using the communication module 902, where the second response information indicates that the first TCI state is successfully activated.

Optionally, the first response information includes response information used to respond to the random access. For example, the first response information is a random access response, or other information that is used to respond to the random access. The terminal device considers that the random access succeeds only after receiving the response information that is used to respond to the random access that is returned by the target cell, and further returns the second response information to the source cell. The source cell considers that beam switch succeeds or considers that activation of the first TCI succeeds only after receiving the second response information. In this way, cell handover reliability is improved.

In another embodiment, the communication module 902 is configured to receive indication information from a source cell, where the indication information indicates to activate a first TCI state; and the processing module 901 is configured to: initiate random access to a target cell according to the indication information, and in response to a beam failure occurring, perform beam failure recovery based on a candidate beam configuration of a first reference signal. The first TCI state indicates the first reference signal.

Based on the two embodiments, some optional implementations are provided.

Optionally, the first TCI state indicates the first reference signal; and in response to initiating the random access to the target cell according to the indication information, the processing module 901 is specifically configured to initiate the random access to the target cell based on a first random access resource associated with the first reference signal.

Optionally, a plurality of reference signals of the target cell are associated with a plurality of random access resources, and the first reference signal is one of the plurality of reference signals.

The source cell configures the association relationship between the reference signal and the random access resource for the terminal device in advance, and the processing module 901 is further configured to obtain the association relationship from the source cell. The association relationship is obtained by the source cell by using a received system message of the target cell. The processing module 901 is configured to: determine the random access resource based on a configuration of the random access resource of the target cell, and initiate the random access to the target cell. Alternatively, after receiving the indication information from the source cell by using the communication module 902, the processing module 901 attempts to receive system information or a broadcast message in the target cell, obtain the configuration of the random access resource, and initiate the random access in the target cell.

Optionally, the first TCI state indicates the first reference signal, and the processing module 901 is further configured to: after initiating the random access to the target cell, in response to a beam failure occurring, perform beam failure recovery based on a candidate beam configuration of the first reference signal.

In a possible design, the first response information includes response information used to respond to the beam failure recovery. For example, the first response information is a beam failure request response, or other information that is used to respond to the beam failure recovery. After the terminal device performs the beam switch-based cell handover, a beam switch failure occurs. After receiving the response information used to respond to the beam failure recovery, the terminal device returns, to the source cell, the second response message that indicates that activation of the first TCI state succeeds, cell handover succeeds, or beam switch succeeds. In this way, reliability and robustness of successful cell handover is further ensured.

Optionally, in response to performing the beam failure recovery based on the candidate beam configuration of the first reference signal, the processing module 901 is specifically configured to: measure one or more reference signals in the candidate beam configuration of the first reference signal; select a second reference signal in the candidate beam configuration according to a measurement result; and send a beam failure recovery request to the target cell based on the uplink resource associated with the second reference signal.

Optionally, the communication module 902 is further configured to receive configuration information from the source cell, where the configuration information includes a downlink resource used to receive the beam failure recovery request response. The processing module 901 is further configured to receive the beam failure recovery request response from the target cell based on the downlink resource.

In a possible design, the processing module 901 is further configured to: in response to the first response information returned by the target cell not being received, communicate with the source cell based on a second TCI state used before the first TCI state is successfully activated. For example, a PDCCH from the source cell is received based on a QCL relationship indicated by the second TCI state.

The communication module 902 is further configured to perform another receiving or sending step or operation performed by the terminal device in the foregoing method embodiments. The processing module 901 is further configured to perform another corresponding step or operation performed by the terminal device in the foregoing method embodiments other than the sending and receiving. Details are not described herein again.

In response to the apparatus being configured to perform the method performed by the network device, the processing module 901 is configured to send, by using the communication module 902, indication information to the terminal device based on a quasi-colocation QCL relationship indicated by the first TCI state, where the indication information indicates to activate the second TCI state, and the indication information is used by the terminal device to initiate random access to the target cell; and the communication module 902 is further configured to receive an acknowledgement from the terminal device, where the acknowledgement indicates that the second TCI state is successfully activated.

Generally, the acknowledgement is sent by using physical layer signaling, or is sent by using MAC layer signaling. A delay of the physical layer and the MAC layer is lower than that of a layer 3, that is, an RRC layer. Therefore, the delay of a cell handover is reduced.

In a possible design, the processing module 901 is configured to: in response to a negative acknowledgement being received from the terminal device, communicate with the terminal device by using the QCL relationship indicated by the first TCI state.

The communication module 902 is further configured to perform another receiving or sending step or operation performed by the source cell in the foregoing method embodiments. The processing module 901 is further configured to perform another corresponding step or operation performed by the source cell in the foregoing method embodiments other than the sending and receiving. Details are not described herein again.

Division into modules in at least one embodiment is an example, is merely logical function division, and is other division in an actual implementation. In addition, functional modules in embodiments described herein is integrated into one processor, or each of the modules exist alone physically, or two or more modules is integrated into one module. The integrated module is implemented in a form of hardware, or is implemented in a form of a software function module.

FIG. 10 shows a communication apparatus 1000 according to at least one embodiment. The communication apparatus 1000 is configured to implement a function of the terminal device or the network device in the foregoing methods. In response to implementing a function of a source cell, the communication apparatus is a network device of the source cell, or is an apparatus in the network device of the source cell, or is an apparatus that is used in matching with the network device of the source cell. In response to a function of a terminal device being implemented, the communication apparatus is a terminal device, or is an apparatus in the terminal device, or is an apparatus that is used in matching with the terminal device. The communication apparatus is a chip system. In at least one embodiment, the chip system includes a chip, or includes a chip and another discrete component. The communication apparatus 1000 includes at least one processor 1020, configured to implement the function of the terminal device or the network device of the source cell in the methods provided in embodiments described herein. The communication apparatus 1000 further includes a communication interface 1010. In at least one embodiment, the communication interface is a transceiver, a circuit, a bus, a module, or a communication interface of another type, and is configured to communicate with another device through a transmission medium. A transceiver includes a receiver and a transmitter. The receiver is configured to implement a receiving operation in the method embodiments, and the transmitter is configured to implement a sending operation in the method embodiments. Other operations are performed by the processor. In response to the communication apparatus is the chip system, the communication interface 1010 includes an input interface and an output interface. The input interface correspondingly performs a receiving operation, and the output interface correspondingly performs a sending operation.

For example, the communication interface 1010 is used by an apparatus in the communication apparatus 1000 to communicate with another device. For example, in response to the communication apparatus 1000 being a network device, the another device is a terminal device. In response to the communication apparatus 1000 being a terminal device, the another device is a network device. The processor 1020 receives and sends data through the communication interface 1010, and is configured to implement the methods in the foregoing method embodiments. For example, in response to a function of the terminal device being implemented, in an embodiment, the communication interface 1010 is configured to receive indication information from the source cell, where the indication information indicates to activate the first TCI state. The processor 1020 is configured to initiate random access to the target cell according to the indication information, and is configured to: in response to first response information returned by the target cell being received, return second response information to the source cell through the communication interface 1010, where the second response information indicates that the first TCI state is successfully activated. Optionally, the first response information includes response information used to respond to the random access. For example, the first response information is a random access response, or other information that is used to respond to the random access. The terminal device considers that the random access succeeds only after receiving the response information that is used to respond to the random access that is returned by the target cell, and further returns the second response information to the source cell. The source cell considers that beam switch succeeds or considers that activation of the first TCI succeeds only after receiving the second response information. In this way, cell handover reliability is improved. In another embodiment, the communication interface 1010 is configured to receive indication information from the source cell, where the indication information indicates to activate the first TCI state, and the processor 1020 is configured to: initiate random access to the target cell according to the indication information, and in response to a beam failure occurring, perform beam failure recovery based on a candidate beam configuration of a first reference signal, where the first TCI state indicates the first reference signal. Based on the two embodiments, some optional implementations are provided.

Optionally, the first TCI state indicates the first reference signal; and in response to initiating random access to the target cell according to the indication information, the processor 1020 is specifically configured to initiate the random access to the target cell based on a first random access resource associated with the first reference signal.

Optionally, a plurality of reference signals of the target cell are associated with a plurality of random access resources, and the first reference signal is one of the plurality of reference signals.

The source cell configures the association relationship between the reference signal and the random access resource for the terminal device in advance, and the processor 1020 is further configured to obtain the association relationship from the source cell. The association relationship is obtained by the source cell by using a received system message of the target cell. The processor 1020 is configured to determine the random access resource based on a configuration of the random access resource of the target cell, and initiate the random access to the target cell. Alternatively, after receiving the indication information from the source cell through the communication interface 1010, the processor 1020 attempts to receive system information or a broadcast message in the target cell, obtain a configuration of the random access resource, and initiate the random access in the target cell.

Optionally, the first TCI state indicates the first reference signal, and the processor 1020 is further configured to: after initiating the random access to the target cell, in response to a beam failure occurring, perform beam failure recovery based on a candidate beam configuration of the first reference signal.

In a possible design, the first response information includes response information used to respond to the beam failure recovery. For example, the first response information is a beam failure recovery request response, or other information used to respond to the beam failure recovery. After the terminal device performs the beam switch-based cell handover, a beam switch failure occurs. After receiving the response information used to respond to the beam failure recovery, the terminal device returns, to the source cell, the second response message that indicates that activation of the first TCI state succeeds, cell handover succeeds, or beam switch succeeds. In this way, reliability and robustness of successful cell handover is further ensured.

Optionally, in response to performing the beam failure recovery based on the candidate beam configuration of the first reference signal, the processor 1020 is specifically configured to: measure one or more reference signals in the candidate beam configuration of the first reference signal; select a second reference signal in the candidate beam configuration according to a measurement result; and send a beam failure recovery request to the target cell based on the uplink resource associated with the second reference signal.

Optionally, the communication interface 1010 is further configured to receive configuration information from the source cell, where the configuration information includes a downlink resource used to receive the beam failure recovery request response. The processor 1020 is further configured to receive the beam failure recovery request response from the target cell based on the downlink resource.

In a possible design, the processor 1020 is further configured to: in response to the first response information returned by the target cell not being received, communicate with the source cell based on a second TCI state used before the first TCI state is successfully activated. For example, a PDCCH from the source cell is received based on a QCL relationship indicated by the second TCI state.

The communication interface 1010 is further configured to perform another receiving or sending step or operation performed by the terminal device in the foregoing method embodiments. The processor 1020 is further configured to perform another corresponding step or operation performed by the terminal device in the foregoing method embodiments other than the sending and receiving. Details are not described herein again.

In response to the apparatus being configured to perform the method performed by the network device, the processor 1020 is configured to send indication information to the terminal device based on the quasi-colocation QCL relationship indicated by the first TCI state through the communication interface 1010, where the indication information indicates to activate the second TCI state, and the indication information is used by the terminal device to initiate random access to the target cell; and the communication interface 1010 is further configured to receive an acknowledgement from the terminal device, where the acknowledgement indicates that the second TCI state is successfully activated.

Generally, the acknowledgement is sent by using physical layer signaling, or is sent by using MAC layer signaling. A delay of the physical layer and the MAC layer is lower than that of a layer 3, that is, an RRC layer. Therefore, the delay of a cell handover is reduced.

In a possible design, the processor 1020 is configured to: in response to a negative acknowledgement being received from the terminal device, communicate with the terminal device by using the QCL relationship indicated by the first TCI state.

The communication interface 1010 is further configured to perform another receiving or sending step or operation performed by the source cell in the foregoing method embodiments. The processor 1020 is further configured to perform another corresponding step or operation performed by the source cell in the foregoing method embodiments other than the sending and receiving. Details are not described herein again.

The communication apparatus 1000 further includes at least one memory 1030, configured to store program instructions and/or data. The memory 1030 is coupled to the processor 1020. The coupling in at least one embodiment is indirect coupling or a communication connection between apparatuses, units, or modules in an electrical form, a mechanical form, or another form, and is used for information exchange between the apparatuses, the units, or the modules. The processor 1020 cooperates with the memory 1030. The processor 1020 executes the program instructions stored in the memory 1030. At least one of the at least one memory is included in the processor.

A specific connection medium between the communication interface 1010, the processor 1020, and the memory 1030 is not limited in at least one embodiment. In at least one embodiment, the memory 1030, the processor 1020, and the communication interface 1010 are connected through a bus 1040 in FIG. 10. The bus is represented by using a bold line in FIG. 10. A connection manner between other components is merely an example for description, and does not impose a limitation. The bus is classified into an address bus, a data bus, a control bus, and the like. For ease of representation, only one bold line is used to represent the bus in FIG. 10, but this does not mean that there is only one bus or only one type of bus.

In response to the communication apparatus 900 and the communication apparatus 1000 being specifically a chip or a chip system, the communication module 902 and the communication interface 1010 outputs or receive a baseband signal. In response to the communication apparatus 900 and the communication apparatus 1000 being specifically devices, the communication module 902 and the communication interface 1010 outputs or receive a radio frequency signal. In at least one embodiment, the processor is a general-purpose processor, a digital signal processor, an application-specific integrated circuit, a field programmable gate array or another programmable logic device, a discrete gate or transistor logic device, or a discrete hardware component. The processor implements or performs the methods, steps, and logical block diagrams disclosed in embodiments described herein. The general-purpose processor is a microprocessor, any conventional processor, or the like. The steps of the methods disclosed with reference to embodiments described herein are directly performed and completed by a hardware processor, or is performed and completed by using a combination of hardware and software module in the processor.

In at least one embodiment, the memory 1030 is a non-volatile memory such as a hard disk drive (hard disk drive, HDD) or a solid-state drive (solid-state drive, SSD), or is a volatile memory (volatile memory) such as a random access memory (random access memory, RAM). The memory is any other medium that is used to carry or store expected program code in a form of instructions or a data structure and that is accessed by a computer, but is not limited thereto. Alternatively, the memory in at least one embodiment is a circuit or any other apparatus that can implement a storage function, and is configured to store the program instructions and/or data.

Some or all of operations and functions performed by the terminal described in the foregoing method of embodiments described herein, or some or all of operations and functions performed by the network device is completed by using a chip or an integrated circuit.

To implement functions of the communication apparatus in FIG. 9 or FIG. 10, at least one embodiment further provides a chip, including one or more processors, configured to support the communication apparatus in implementing functions related to the terminal or the source cell in the foregoing method embodiments. In a possible design, the chip is connected to the memory, or the chip includes the memory. The memory is configured to store program instructions and data that are used for the communication apparatus.

At least one embodiment provides a computer readable storage medium. The computer readable storage medium stores a computer program. The computer program includes instructions used to perform the foregoing method embodiments.

At least one embodiment provides a computer program product that includes instructions. In response to the computer program product running on a computer, the foregoing method embodiments are implemented. Persons skilled in the art should understand that at least one embodiment is provided as a method, a system, or a computer program product. Therefore, at least one embodiment uses a form of hardware only embodiments, software only embodiments, or embodiments with a combination of software and hardware. Moreover, at least one embodiment uses a form of a computer program product that is implemented on one or more computer-usable storage media (including but not limited to a disk memory, a CD-ROM, an optical memory, and the like) that include computer usable program code.

At least one embodiment is described with reference to the flowcharts and/or block diagrams of the method, the device (system), and the computer program product according to at least one embodiment. Computer program instructions are used to implement each process and/or each block in the flowcharts and/or the block diagrams and a combination of a process and/or a block in the flowcharts and/or the block diagrams. These computer program instructions is provided for a general-purpose computer, a special-purpose computer, an embedded processor, or a processor of another programmable data processing device to generate a machine, so that the instructions executed by a computer or the processor of another programmable data processing device generate an apparatus for implementing a specific function in one or more processes in the flowcharts and/or in one or more blocks in the block diagrams.

These computer program instructions is alternatively stored in a computer-readable memory that leads the computer or another programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions is alternatively loaded onto a computer or another programmable data processing device, so that a series of operation steps are performed on the computer or another programmable device, thereby generating computer-implemented processing. Therefore, the instructions executed on the computer or another programmable device provide steps for implementing a specific function in one or more processes in the flowcharts and/or in one or more blocks in the block diagrams.

Although at least one embodiment is described, persons skilled in the art are able to make changes and modifications to these embodiments once they learn of the basic inventive concept. Therefore, the following claims are intended to be construed as to cover the preferred embodiments and all changes and modifications falling within the scope of embodiments described herein.

Persons skilled in the art are able to make various modifications and variations without departing from the scope of embodiments described herein. In this way, at least one embodiment is intended to cover these modifications and variations provided that they fall within the scope of protection defined by the following claims and their equivalent technologies.

1. A cell handover method, comprising:
receiving indication information from a source cell, wherein the indication information indicates a first transmission configuration indicator (TCI) state and cell handover;
initiating random access to a target cell according to the indication information.

2. The method according to claim 1, wherein the first TCI state indicates a first reference signal; and
the initiating random access to a target cell according to the indication information includes: initiating the random access to the target cell based on a first random access resource associated with the first reference signal.

3. The method according to claim 1, wherein the method further comprises:
receiving an association relationship between a random access resource and a first reference signal from the source cell;
wherein the initiating random access to a target cell according to the indication information includes:
initiating random access to the target cell based on the indication information by using the first random access resource associated with the first reference signal.

4. The method according to claim 2, wherein the using the first random access resource includes using a physical random access channel time-frequency resource and/or a random access preamble.

5. The method according to claim 1, wherein the method further comprises:
receiving a configuration of a random access resource of the target cell, wherein the configuration of the random access resource is used to determine the random access resource of the target cell;
wherein the initiating random access to a target cell according to the indication information includes:
initiating random access to the target cell according to the indication information by using the random access resource.

6. The method according to claim 2, wherein there is an association relationship between a plurality of reference signals of the target cell and a plurality of random access resources, and the first reference signal is one of the plurality of reference signals.

7. The method according to claim 1, wherein the receiving the indication information from a source cell includes receiving one or more of the following: an identifier of a terminal device, an identifier of a neighboring cell, an identifier of a bandwidth part, an identifier of a carrier, an identifier of a random access resource, or an identifier of a target beam.

8. The method according to claim 7, wherein the receiving the identifier of the target beam includes receiving one or more of the following: an identifier of a TCI state or an uplink TCI identifier.

9. The method according to claim 7, wherein the receiving the identifier of the random access resource includes receiving a random access preamble.

10. The method according to claim 1, wherein the method further comprises:
receiving configuration information from the source cell, wherein the configuration information includes a physical layer measurement configuration, and the physical layer measurement configuration includes synchronization signal block (SSB) information of a neighboring cell; and;
measuring the SSB of the neighboring cell according to the physical layer measurement configuration; and;
reporting the SSB measurement result of the neighboring cell to the source cell.

11. The method according to claim 1, wherein the receiving the indication information from a source cell includes receiving the indication information carried by a medium access control-control element (MAC-CE).

12. The method according to claim 1, wherein receiving the indication information from a source cell that indicates the first TCI state includes receiving the indication information from a source cell that indicates one or more of the following: an identifier of a TCI status or an identifier of uplink TCI.

13. The method according to claim 1, wherein the receiving the indication information from a source cell includes receiving the indication information used to instruct to activate the first TCI state.

14. The method according to claim 13, wherein the method further comprises:
in response to first response information returned by the target cell being received, returning second response information to the source cell, wherein the second response information indicates that the first TCI state is successfully activated.

15. A communication apparatus, comprising:
a transceiver, configured to receive indication information from a source cell, wherein the indication information indicates to activate a first transmission configuration indicator (TCI) state and cell handover; and
a processor, configured to: initiate random access to a target cell according to the indication information.

16. The apparatus according to claim 15, wherein the first TCI state indicates a first reference signal; and
the processor is further configured to initiate the random access to the target cell based on a first random access resource associated with the first reference signal.

17. The apparatus according to claim 15, wherein the transceiver is further configured to:
receive an association relationship between a random access resource and a first reference signal from the source cell; and;
initiate random access to the target cell based on the indication information by using the first random access resource associated with the first reference signal.

18. The apparatus according to claim 15, wherein:
the transceiver is further configured to receive a configuration of a random access resource of the target cell, wherein the configuration of the random access resource is used to determine the random access resource of the target cell; and;
the processor is further configured to initiate random access to the target cell according to the indication information by using the random access resource.

19. The apparatus according to claim 15, wherein the indication information includes one or more of the following: an identifier of a terminal device, an identifier of a neighboring cell, an identifier of a bandwidth part, an identifier of a carrier, an identifier of a random access resource, and an identifier of a target beam.

20. The apparatus according to claim 15, wherein:
the transceiver is further configured to receive configuration information from the source cell, wherein the configuration information includes a physical layer measurement configuration, and the physical layer measurement configuration includes synchronization signal block (SSB) information of a neighboring cell; and;
the processor is further configured to measure the SSB of the neighboring cell according to the physical layer measurement configuration; and;
the transceiver is further configured to report the SSB measurement result of the neighboring cell to the source cell.
